(19) United States
(12) Patent Application Publication
(10) Pub. No.: US 2007/0146494 A1
(43) Pub. Date: Jun. 28, 2007

(54) Video telephony system and a method for use in the video telephony system for improving image quality

(76) Inventors: Glen P. Goffin, Dublin, PA (US); Thomas J. Doblmaier, North Wales, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/316,237

(22) Filed: Dec. 22, 2005

(51) Int. Cl. H04N 5/228

(52) U.S. Cl. 348/222.1

(57) ABSTRACT

A method and apparatus are provided for determining lighting conditions in a video telephony environment, and for causing one or more tasks to be performed that will lead to an improvement in image quality. These tasks include, for example, (1) informing the user of the lighting conditions, (2) suggestion to the user ways to improve the lighting conditions, and (3) automatically compensating for the lighting conditions.

### TECHNICAL FIELD OF THE INVENTION

The invention relates to video telephones. More particularly, the invention relates to determining lighting conditions in the environment where the video telephony system is being used, and for performing one or more tasks in accordance with the determined lighting conditions to improve the quality of images captured and/or transmitted by the system.

### BACKGROUND OF THE INVENTION

Video systems capture light reflected off of desired people and objects and convert those light signals into electrical signals that can then be stored or transmitted. All of the light signals reflected off of an object in one general direction comprise an image, or an optical counterpart, of that object. Video systems capture numerous images per second. This allows for the video display system to project multiple images per second back to the user so the user observes continuous motion. While each individual image is only a snapshot of the person or object being displayed, the video display system displays more images than the human eye and brain can process every second. In this way, the gaps between the individual images are never perceived by the user. Instead the user perceives continuous movement.

In many video systems, images are captured using an image pick-up device such as a charged-coupled device (CCD) sensor or a Complementary Metal Oxide Semiconductor (CMOS) sensor. This sensor is sensitive to light and accumulates an electrical charge when light is shone upon it. The more light shone upon the sensor, the more charges it accumulates.

The intensity of light over a given area is called luminance. The greater the luminance, the brighter the light and the more electrons will be captured by the sensor for a given time period. Any image captured by a sensor under low-light conditions will result in fewer electrons or charges being accumulated than under high-light conditions. These images will have lower luminance values.

Similarly, the longer light is shone upon a sensor the more electrical charge it accumulates until saturation. Thus, an image that is captured for a very short amount of time will result in fewer electrons or charges being accumulated than if the sensor is allowed to capture the image for a longer period of time.

Low-light conditions can be especially problematic in video telephony systems. In particular, the capturing of light from people's eyes. The eyes are shaded by the brow causing less light to reflect off of the eyes and into the video telephone. This in turn causes the eyes to become dark and distorted when the image is reconstituted for the other user. This problem is magnified when the image data pertaining to the person's eyes is compressed so that fine details, already difficult to obtain in low-light conditions, are lost. This causes the displayed eyes to be darker and more distorted. In addition, as the light diminishes the noise in the image increases along with an overall loss of image definition. In other words, as light levels diminish, the automatic gain control (AGC) increases gain to increase the signal level, but this also causes noise to be amplified.

As described above, in order to “trick” the eye and brain, video imaging requires multiple images per second. It is therefore necessary to capture many images from the sensor array every second. That is, the charges captured by the sensor must be moved to a processor for storage or transmission quickly to allow for a new image to be captured. This process must happen several times every second.

A typical sensor contains thousands or even millions of individual cells. Each cell collects light for a single point or pixel and converts that light into an electrical signal. A pixel is the smallest amount of light that can be captured or displayed by a video system. To capture a two-dimensional light image, the sensor cells are arranged in a two dimensional array. A two-dimensional video image is called a frame. A typical frame contains, for example, 307,200 pixels arranged in 480 rows and 640 columns. This frame changes 30 times every second. Thus, in this case, the sensor must capture 30 images per second to produce an ATSC compliant frame. With frame rates of such high speeds, poor lighting conditions result in even greater overall loss of image definition.

Currently, video telephony systems that are available in the market do not provide for detecting or varying lighting conditions. Consequently, if lighting conditions are poor, nothing is done to improve lighting conditions, or to otherwise improve image quality under poor lighting conditions. Accordingly, a need exists for a way to detect lighting conditions in a video telephony environment. A need also exists for a way to improve lighting conditions if deemed necessary or desirable, or to otherwise improve image quality under poor lighting conditions.

### SUMMARY OF THE INVENTION

The invention is directed to a video telephony system, and a method and apparatus for use in the video telephony system for determining lighting conditions and for performing one or more tasks to improve image quality based on the determination of the lighting conditions.

The system comprises a camera for capturing images of a user of the system, and a processor configured to determine the lighting conditions in the environment in which the system is located, and to perform one or more tasks in accordance with the determined lighting conditions to improve the quality of the images captured and/or transmitted by the system.

The method comprises determining lighting conditions in an environment. in which the video telephony system is located, and performing one or more tasks in accordance with the determined lighting conditions to improve the quality of images captured and/or transmitted by the video telephony system.

The invention also provides a computer-readable medium having a computer program embodied thereon comprising instructions for determining lighting conditions in an environment in which the video telephony system is located, and instructions for performing one or more tasks in accordance with the determined lighting conditions to improve the quality of images captured and/or transmitted by the video telephony system.

These and other features and advantages of the invention will become apparent from the following description, drawings and claims.

### BRIEF DESCRIPTION OF THE DRAWINGS

FIG. 1 illustrates a functional block diagram of a video telephony system 1 in accordance with an exemplary embodiment of the invention.

FIG. 2 illustrates a flowchart that demonstrates the method of the invention in accordance with an exemplary embodiment for using one or more light sensors to detect lighting conditions and for providing the user with information regarding the lighting conditions.

FIG. 3 illustrates a flowchart that demonstrates the method of the invention in accordance with an exemplary embodiment for using the automatic gain control (AGC) and/or automatic luminance control (ALC) signals to determine current lighting conditions.

FIG. 4 illustrates a flowchart that demonstrates the method of the invention in accordance with an exemplary embodiment for using image processing to determine lighting conditions.

FIG. 5 illustrates a flowchart of the method in accordance with an exemplary embodiment of the invention for automatically compensating for lighting conditions.

### DETAILED DESCRIPTION OF AN EXEMPLARY EMBODIMENT

In accordance with the invention, a method and apparatus are provided for determining lighting conditions in a video telephony environment, and for causing one or more tasks to be performed in accordance with the determination of the lighting conditions that will lead to an improvement in image quality. These tasks include, for example, (1) informing the user of the lighting conditions, (2) suggestion to the user ways to improve the lighting conditions, and (3) automatically compensating for the lighting conditions.

Back-lighting corresponds to light projected into the camera of the video telephony system from behind the user. Severe back-lighting can swamp out the image. Side-lighting is light from the side of the user. Severe side-lighting an d severe overhead lighting can create shadows and make facial features unrecognizable. These are examples of poor lighting conditions that are detected and remedied by the invention.

At the outset, it should be noted that the features and functionality discussed herein may be embodied in a video telephony system that can transmit and receive information over any of a variety of different external communication media supporting any type of service, including voice over broadband (VOBB) and legacy services. VoBB is defined herein to include voice over cable modem (VoCM), voice over DSL (VoDSL), voice over Internet protocol (VoIP), fixed wireless access (FWA), fiber to the home (FTTH), and voice over ATM (VoATM). Legacy services include the integrated service digital network (ISDN), plain old telephone service (POTS), cellular and 3G. Accordingly, the external communication medium may be a wireless network, a convention telephone network, a data network (e.g., the Internet), a cable modem system, a cellular network and the like.

Various industry standards have been evolving for video telephony services such as those promulgated by the International Telecommunications Union (ITU). The standards and protocols that are employed will depend on the external communication medium that is used to communicate the voice and audio information. For example, if the video telephony system employs a POTS service, protocols may be employed such as the CCITT H.261 specification for video compression and decompression and encoding and decoding, the CCITT H.221 specification for full duplex synchronized audio and motion video communication framing, the CCITT H.242 specification for call setup and disconnect. On the other hand, video telephony devices operating over the Internet can use protocols embodied in video conference standards such as H.323 as well as H.263 and H.264 for video encoding and G.723.1, G.711 and G.729 for audio encoding, as well as the Internet Engineering Task Force (IETF) standards for session initiated protocol (SIP) devices, real time transport protocol (RTP) devices, real-time control protocol (RTCP) devices, etc.

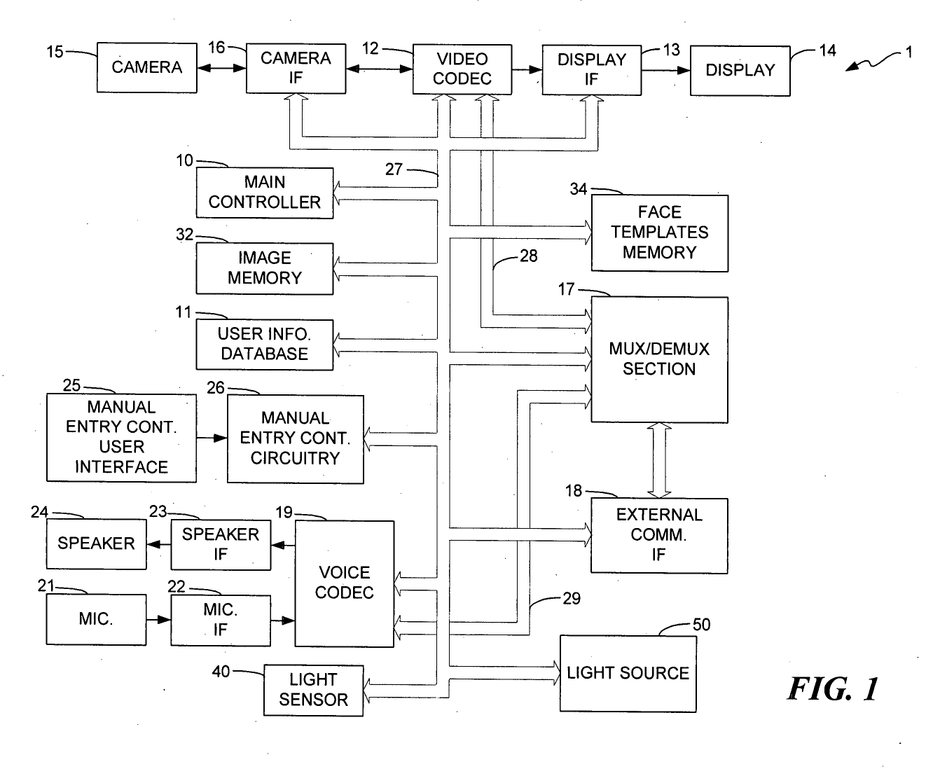

FIG. 1 illustrates a functional block diagram of a video telephony system 1 in accordance with an exemplary embodiment of the invention. It should be noted that the video telephony system of the invention may, but need not, include all of the components shown in FIG. 1. It should also be noted that the components shown in FIG. 1 are applicable across the various telephony platforms and protocols mentioned above. That is, the video telephony system 1 may be, without limitation, an analog phone, an ISDN phone, an analog cellular phone, a digital cellular phone, a PHS phone, an Internet telephone, and so on. Of course, the implementation of each component and the standards and protocols employed will typically differ from platform to platform.

The system 1 comprises a main controller 10, a personalized user information database 11, an image memory 32, a face template memory 34, a video codec 12, an display interface 13, a display unit 14 such as an liquid crystal display (LCD), a camera portion 15, a camera interface 16, a multiplexing and separating section 17, an external communications interface 18, a voice codec 20, a microphone 21, a microphone interface 22, a speaker interface 23, a speaker 24, a manual control portion 25, and a manual entry control circuit portion 26. The manual control portion 25 may be, for example, a telephone handset and/or other user interface components (e.g., a touchscreen) that allow the user to properly use the video telephony system 1. Of course, other interfaces and interface components that are not shown may also be incorporated into the system 1, such as, for example, Universal Serial Bus (USB) and Bluetooth interfaces, cordless handset interfaces, etc.

Of these components, the main controller 10, the personalized user interface database 11, the image memory 32, the video codec 12, the LCD interface 13, the camera interface 16, the multiplexing and separating section 17, the communications interface 18, the voice codec 20, and the manual entry control circuit portion 26 are connected together via a main bus 27.

The multiplexing and separating section 17, which manages the incoming and outgoing video and audio data to and from the external communications network, is connected with the video codec 12, the communications system interface 18, and the voice codec 19 via sync buses 28, 29, and 30, respectively. The main controller 10 includes a CPU, a ROM, a RAM, and so on. The operations of the various portions of the video telephony system 1 are under control of the main controller 10. The main controller 10 performs various functions in software according to data stored in the ROM, RAM, personalized user information database 11, image memory 32 and face template memory 34.

The personalized user information database 11 is used to store a database of information for each registered user. Each database is composed of plural records. Each record may comprise, for instance, a personal phonebook (including, e.g., a phone book memory number, a phone number, a name, a home address, a business address, an email address, and any other appropriate information), a personally configured graphical user interface (GUI) for display on display unit 14, and/or personal ringtone(s), alerts, screensavers, call logs, buddy lists, journals, blogs, and web sites or other preferences. When retrieved, the personal phonebook may be presented to the user on the display unit 14.

The video codec 12 decodes and reproduces encoded video data, and sends the reproduced video data to the display interface 13. Furthermore, the video codec 12 encodes video data supplied from the camera portion 15 via the camera interface 16 and creates video data encoded in accordance with, for example, the MPEG-4 standard or the like.

The display interface 13 converts the video data supplied from the video codec 12 into a signal form that can be processed by the display 14, and sends the converted data to the display 14. The display 14 may be, for example, a color or monochrome LCD display having sufficient video displaying capabilities (such as resolution) to display video with MPEG-4 or the like, and displays a picture according to video data supplied from the display interface 13.

For example, a CCD or CMOS camera may be used as the camera 15, which picks up an image of an object, creates video data, and sends it to the camera interface 16. The camera interface 16 receives the video data from the camera 15, converts the data into a form that can be processed by the video codec 12, and supplies the data to the codec 12.

The multiplexing and separating portion 17 is responsible for managing the incoming and outgoing video and audio data to and from the external communications network via communications system interface 18. Specifically, the multiplexing and separating portion 17 multiplexes encoded video data supplied from the video codec 12 via the sync bus 28, the encoded audio data supplied from the voice codec 19 via the sync bus 30, and other data supplied from the main controller 10 via the main bus by a given method (e.g., H.221). The multiplexing and demultiplexing portion 17 supplies the multiplexed data as transmitted data to the external communications interface 18 via the sync bus 29.

The multiplexing and demultiplexing portion 17 demultiplexes encoded video data, encoded audio data, and other data from the transmitted data supplied from the communications interface 18 via the sync bus 29. The multiplexing and demultiplexing portion 17 supplies the demultiplexed data to the video codec 12, the voice codec 20, and the main controller 10 via the sync buses 28, 29, and the main bus 27, respectively.

The external communications interface 18 is used to make a connection to the external communications network, which, as previously mentioned, may be any suitable network such as, but not limited to, a wireless network, a conventional telephone network, a data network (e.g., the Internet), and a cable modem system. The interface 18 makes various calls for communications via the communications network and sends and receives voice and video data via communications paths established in the network.

The voice codec 19 digitizes analog audio signals applied via the microphone 21 and the microphone interface. The codec 19 encodes the signal by a given audio encoding method such as, for example, ADPCM to create encoded audio data, and sends the encoded audio data to the multiplexing and demultiplexing portion 17 via the sync bus 30.

The voice codec 19 decodes the encoded audio data supplied from the multiplexing and demultiplexing portion 17 into an analog audio signal, which is supplied to the speaker interface 23.

The microphone 21 converts sound from the surroundings into an audio signal and supplies it to the microphone interface 22, which in turn converts the audio signal supplied from the microphone 21 into a signal form that can be processed by the voice codec 19 and supplies it to the voice codec 19.

The speaker interface 23 converts the audio signal supplied from the voice codec 19 into a signal form capable of being processed by the speaker 24, and supplies the converted signal to the speaker 24. The speaker 24 converts the audio signal supplied from the speaker interface 23 into an audible signal at an increased level.

The manual entry control user interface 25, which preferably is a graphical user interface (GUI), receives various instructions input by the user to be performed by the main controller 10. The interface 25 preferably includes control buttons for specifying various functions, push buttons for entering phone numbers and various numerical values, and a power switch for turning on and off the operation of the present terminal. The manual entry control circuitry 26 recognizes the contents of an instruction entered from the manual entry control user interface 25 and informs the main controller 10 of the contents of the instruction. The main controller 10 then causes the corresponding functions to be performed.

The manual entry control user interface 25 includes a display that displays information to the user, which may be in the form of icons and level indicators that provide the user with certain useful information. The display of the user interface 25 displays information that indicates to the user whether the lighting conditions are, for example, adequate or need to be improved, and/or provides suggestions for improving the lighting conditions. The system 1 may include one or more light sensors 40 that sense the lighting conditions. In this case, the sensed lighting conditions are reported to the main controller 10, which then causes the display of the user interface 25 to display the corresponding information regarding the lighting conditions and/or suggestions as to how to improve the lighting conditions. If the light sensor(s) 40 is used, it will typically be aimed at a zone where a user would normally have their face during a call.

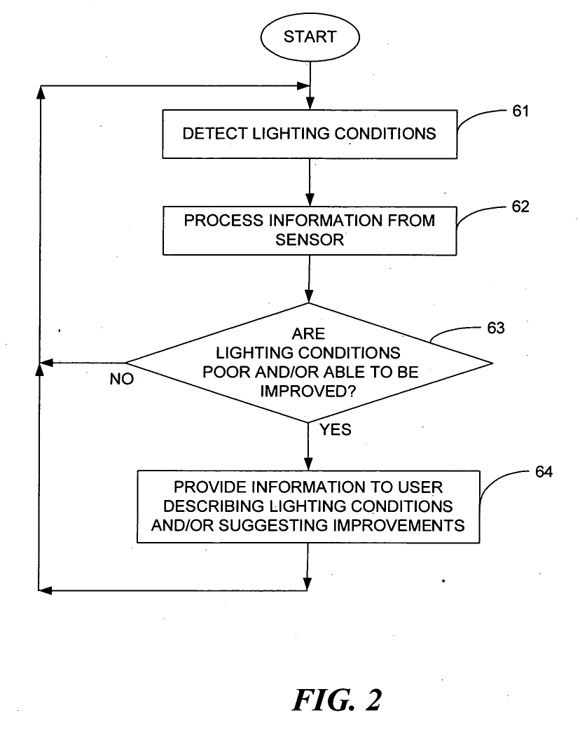

FIG. 2 illustrates a flowchart that demonstrates the method of the invention in accordance with an exemplary embodiment for using one or more light sensors to detect lighting conditions and for providing the user with information regarding the lighting conditions. The light sensor(s) 40 detect the level of light and report it to the main controller, as indicated by block 61. The main controller 10 receives information from the light sensor(s) 40 indicating the level of light and processes the information, as indicated by block 62. The main controller 10 processes the information and determines whether the level of light indicates poor lighting conditions, or whether the lighting conditions can be improved, as indicated by block 63. This may be accomplished in a variety of ways. Typically, the main controller 10 performs an algorithm that processes light levels detected by multiple light sensors arranged in a pattern that enables the algorithm to differentiate between back-lighting, side-lighting and overhead lighting conditions. If the main controller 10 determines that poor lighting conditions do not exist and/or that lighting conditions cannot be improved, the process returns to block 61 and continues through the loop represented by blocks 61-63.

If the main controller 10 determines that poor lighting conditions exist, or that lighting conditions can be improved, the main controller 10 causes information to be displayed to the user that indicates the lighting conditions and/or that suggests how lighting conditions may be improved. This step is represented in FIG. 2 by block 64. This step may be broken into multiple steps. For example, the main controller 10 may determine whether lighting conditions are poor, and if so, display information to the user that indicates that poor lighting conditions exist. If the main controller 10 determines that poor lighting conditions do not exist, the main controller may then determine whether lighting conditions may be improved upon. The main controller 10 may simply cause information to be displayed that describes one or more aspects of the current lighting conditions, without providing suggestions as to how the user may improve lighting conditions. Preferably, suggestions for improving lighting conditions are provided to the user. Also, information describing current lighting conditions and/or suggestions may be displayed on the display of the user interface 25 or on the display 14. Also, although the information preferably is displayed to the user, it may instead be provided to the user in audio.

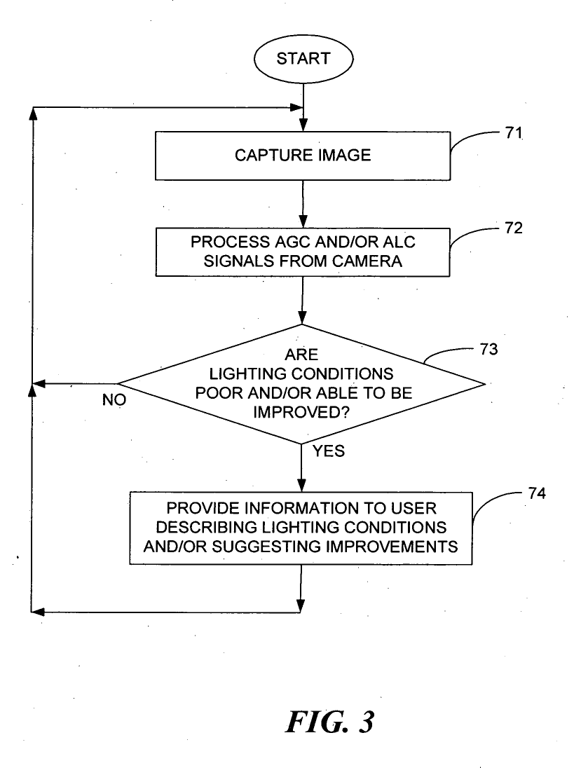

The camera 15 may sense the lighting conditions, in which case the light sensor(s) 40 may not be needed. The camera 15 produces an automatic gain control (AGC) signal and an automatic luminance control (ALC) signal. Either or both of these signals may be used to estimate the lighting conditions. FIG. 3 illustrates a flowchart that demonstrates the method of the invention in accordance with an exemplary embodiment for using the AGC and/or ALC signals to determine current lighting conditions. The main controller 10 may be programmed to execute a software computer program that processes one or both of these signals to obtain an estimate of the lighting conditions and then causes the appropriate information and/or suggestions to be displayed on the display of the user interface 25 to the user.

As shown in FIG. 3, the image is captured by the camera 15, as indicated by block 71. The AGC and/or ALC signals are processed by the main controller 10, as indicated by block 72. The main controller 10 determines whether lighting conditions are poor and/or whether lighting conditions can be improved, as indicated by block 73. If the main controller 10 determines that poor lighting conditions do not exist and/or that lighting conditions cannot be improved, the process returns to block 71 and continues through the loop represented by blocks 71-73. If the main controller 10 determines that poor lighting conditions exist, or that lighting conditions can be improved, the main controller 10 causes information to be displayed to the user that indicates the lighting conditions and/or that suggests how lighting conditions may be improved, as indicated by block 74. Like the step describe above with reference to block 64, the step represented by block 74 may be simplified, expanded upon, broken up into multiple steps.

Image processing may also be used to estimate lighting conditions. Image memory 34 stores one or more facial images of each individual who will be using the video telephony system 1. Prior to use, a registration process will be performed in which these individuals will have their images captured by camera 15 and stored in image memory 32. The images will be associated with the names of each individual, which may be entered manually via the manual control portion 25. The stored images of each individual are converted to a facial representation or template. The representation or template may correspond to an image or simply a set of points and vectors between them identifying selected features of the face. Alternatively, the representation may be a single parameter corresponding to something as simple as eye color or the distance between the individual's eyes. These representations or templates are stored in face templates memory 34. If desired, image memory 32 and face templates memory 34 may be implemented as part of the memory incorporated in main controller 10.

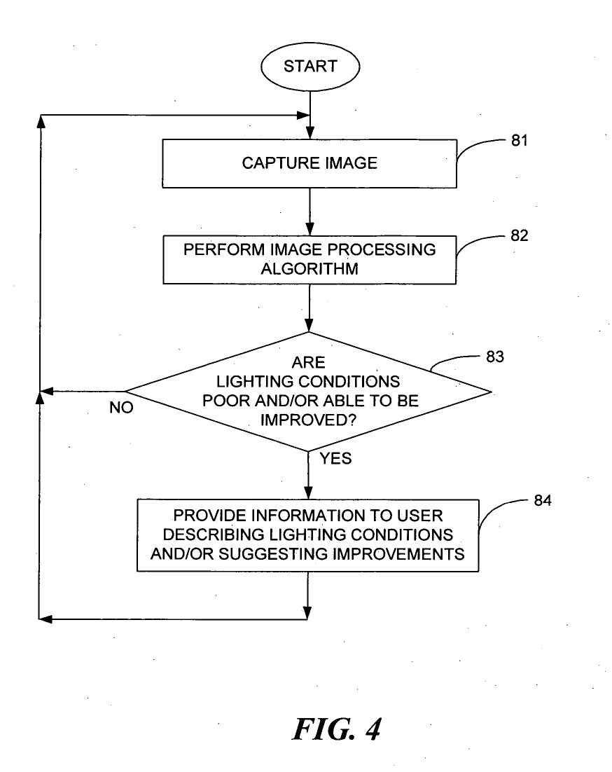

An image processing software program, such as an image recognition program, for example, may be used to analyze one or more facial features of the user of the video telephony system 1 to determine whether or not the lighting conditions need to be adjusted. FIG. 4 illustrates a flowchart that demonstrates the method of the invention in accordance with an exemplary embodiment for using image processing to determine lighting conditions. Images are captured by the camera, as indicated by block 81. The main controller 10 processes the images captured by the camera 15 in accordance with the image processing algorithm, as indicated by block 82. Using the results obtained by the image processing algorithm, the main controller 10 determines whether lighting conditions are poor and/or whether lighting conditions can be improved, as indicated by block 83. This determination may be made in a number of ways. For example, the image processing algorithm may be a face detection or face recognition algorithm that detects one or more facial features and analyzes the features to determine whether poor lighting conditions exist. Poor lighting conditions severely degrade image definition in the regions of the eyes. Such information can be used to determine whether poor lighting conditions exist, and to suggest ways of improving lighting conditions.

If the main controller 10 determines that poor lighting conditions exist, or that lighting conditions can be improved, the main controller 10 causes information to be displayed to the user that indicates the lighting conditions and/or that suggests how lighting conditions may be improved, as indicated by block 84. Like the steps described above with reference to blocks 64 and 74, the step represented by block 84 may be simplified, expanded upon, broken up into multiple steps.

The information that is displayed to the user on the display of the user interface 25 regarding lighting conditions may include, but is not limited to, information in the form of text, symbols, icons and/or level indicators. For example, symbols or icons may be used to indicate that the room is too dark, that the user's face is too dark, that the user's eyes are too dark, that back-lighting is too bright, the side-lighting is too bright, that overhead lighting is too bright, etc. Level indicators such as light emitting diodes, for example, may be used to indicate the lighting conditions. Text displayed in dialog boxes may also be used to indicate lighting conditions.

As stated above, the information displayed to the user may also be used to suggest that the user take certain actions to improve the lighting conditions. This information may also be, but is not limited to, information in the form of text, symbols, icons and/or level indicators. For example, such information may advise the user to, for example, turn the phone to the left or right, reduce the level of overhead lighting, reduce the level of back-lighting, reduce the level of left or right side-lighting, move the phone, etc. A lighting tutorial may be provided to the user in the form of text, audio, video, graphics, etc., that informs the user of actions that can be taken to ensure that lighting conditions are adequate and to advise the user as to changes that can be made to improve lighting conditions.

The main controller 10 may be programmed to execute a “wizard” software program that interactively guides the user to improved lighting conditions. For example, if the phone detects severe backlighting condition, the wizard “pops up” and informs the user of the situation and suggests that the user turn down the lights behind the user, close the window shades, etc. The wizard remains active as the user adjusts the lighting and provides additional guidance such as “The backlighting has improved but now the room is a little too dark. Please turn on some lighting to help light your face a little better.” Thus, the wizard gives real-time, guided feedback to solve the lighting problem. The action taken by the user to improve the lighting conditions is referred to herein as “user assistance”.

The system 1 may also automatically compensate for lighting conditions. For example, the system 1 may include a light source 50 that is controlled by the main controller 10 to adjust the lighting conditions. If information obtained by the main controller 10 from the light sensor 40 and/or the camera 15 indicates that lighting conditions need to be adjusted, the main controller 10 may cause the light source 50 to be adjusted until the main controller determines, based on information obtained from the light sensor 40 and/or the camera 15, that light conditions have been improved to some degree (e.g., as much as possible under the circumstances).

Automatic compensation may also be performed by the system by using a post-processing algorithm to darken overly bright areas of the captured image and to brighten overly dark areas of the captured image. To accomplish this, the main processor 10 processes the pixels in the images and compares the pixel values to a lower threshold value and to a higher threshold value. If the pixels are below the lower threshold values, the pixel values are increased to a particular value. If the pixels are above the higher threshold values, the pixel values are decreased to a particular value.

Automatic compensation may also be performed by the system by adapting the frame rate. As stated above, when lighting conditions are poor, a higher frame rate results in further degradation in image quality. The length of time of the vertical blanking interval is directly related to the desired frames per second. An exemplary 30 frames per second video telephony system either captures or displays a full frame every 33.33 milliseconds (ms). The National Television Systems Committee (NTSC) standard requires that 8% of that time be allocated for the vertical blanking interval. Using this standard as an example, a 30 frames per second system has a vertical blanking interval of 2.66 msec and an active time of 30.66 msec to capture a single frame or image. For a 24 frames per second system, the times are 3.33 msec and 38.33 msec, respectively. Thus, a slower frame rate gives the sensor device of the camera, which is typically a CMOS sensor or a CCD sensor, more time to integrate the collected charge, which increases overall luminance and dynamic range.

A slower vertical synchronization signal (i.e., lower frequency) correlates to a lower frame rate. This means a slower vertical synchronization signal has a longer period, which, in turn, means a longer time to capture an image. Thus, in poor lighting conditions, this longer time means more charges can be captured per frame resulting in better signal level and dynamic range. The main controller 10, upon detecting poor lighting conditions, can cause the camera IF 16 to adjust the vertical synchronization rate of the camera 15 in order to reduce the frame rate to a level that improves image quality.

As stated above, image compression also further degrades image quality when lighting conditions are poor. When images are compressed, image information is lost. Therefore, in poor lighting conditions, decreasing the amount by which the image is compressed can result in better image quality. The main controller 10, upon detecting poor lighting conditions, can cause the video codec 12 to reduce the image compression ratio to achieve a compression level that provides optimum or improved lighting conditions.

Another way to automatically compensate for poor lighting conditions is to adjust the premises lighting where the system 1 is used to improve lighting conditions. Some homes and buildings use lighting networks that have network-connected lighting controls. The system 1 could be interfaced with the lighting network such then when the main controller 10 detects poor lighting conditions, the system 1 communicates information to the lighting network, which then adjusts the lighting controls to improve lighting. For example, if the main controller 10 determines that left side-lighting needs to be adjusted, the system 1 would communicate this information via external communication interface 18 to the lighting network controller, which would then adjust the lighting conditions in the room where the system 1 is located until lighting is optimized or improved.

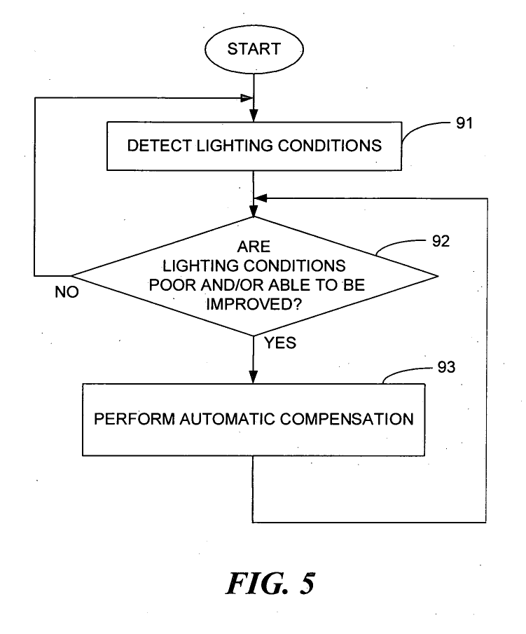

FIG. 5 illustrates a flowchart of the method in accordance with an exemplary embodiment of the invention for automatically compensating for lighting conditions. The lighting conditions are detected, as indicated by block 91. A determination is made as to whether lighting conditions are poor and/or can be improved, as indicated by block 92. If not, the process returns to block 91. If so, automatic compensation is performed, as indicated by block 93. This compensation may be performed by one or more of the techniques described above, e.g., adjusting the illumination source that illuminates the user's face, performing post-processing on the image to improve image quality, adapting frame rate, adapting compression rate, adjusting network-connected lighting controls, etc. Each time an adjustment is made, the process may return to block 92 to determine whether lighting conditions remain poor and/or can be further improved.

The algorithms described above with reference to FIG. 5 are typically implemented by software programs that are executed by the main controller 10. The software programs described above with reference to FIGS. 2-4 are typically also executed by the main controller 10. The main controller 10 may be any type of processor including, for example, a microprocessor, a microcontroller, an application specific integrated circuit (ASIC), a programmable gate array (e.g., PLAs, FPGAs, etc.), etc. It should also be noted that it is not necessary that the main controller 10 perform the algorithms described above with reference to FIGS. 2-5. One or more of these algorithms may be performed by one or more other processors incorporated into the system 1. In addition, the algorithms and programs described above with reference to FIGS. 2-5 may be implemented purely in hardware or in a combination of hardware and software. The term “processor” is used herein to denote any of these and other computational devices that can be suitably configured to perform these corresponding functions.

The software programs described above with reference to FIGS. 2-5 may be embodied in any type of computer-readable medium such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

It should It should be noted that the invention has been described with reference to particular embodiments, and that the invention is not limited to the embodiments described herein. Those skilled in the art will understand that many modifications may be made to the embodiments described herein and that all such modifications are within the scope of the invention.

What is claimed is:

1. A video telephony system comprising:
a camera for capturing images of a user of the system; and
a processor configured to determine lighting conditions in an environment in which the system is located and to perform one or more tasks in accordance with the determined lighting conditions to improve the quality of the images.

2. The system of claim 1, wherein said one or more tasks include informing a user of the system of the lighting conditions by causing information relating to the lighting conditions to be displayed on a display device of the system.

3. The system of claim 2, wherein said one or more tasks include causing information to be displayed on a display device of the system that suggests to the user ways to improve the lighting conditions.

4. The system of claim 1, wherein the information is displayed on the display device in the form of one or more icons.

5. The system of claim 1, wherein the information is displayed on the display device in the form of one or more lighting level indicators.

6. The system of claim 1, wherein the information is displayed on the display device in the form of text.

7. The system of claim 1, wherein the information is displayed on the display device in the form of one or more symbols.

8. The system of claim 1, further comprising:
one or more light sensors for sensing the lighting conditions and for generating lighting information that is provided to the processor, the processor processing the lighting information to determine the lighting conditions and causing said one or more tasks to be performed based on the determination of the lighting conditions.

9. The system of claim 1, wherein the processor receives information from the camera and processes the information to determine the lighting conditions, the processor causing said one or more tasks to be performed based on the determination of the lighting conditions.

10. The system of claim 9, wherein the information received by the processor from the camera includes an automatic gain control (AGC) signal.

11. The system of claim 9, wherein the information received by the processor from the camera includes an automatic luminance control (ALC) signal.

12. The system of claim 9, wherein one of the tasks includes performing an image processing algorithm that analyzes one or more features of the captured images to determine the lighting conditions.

13. The system of claim 1, wherein said one or more tasks include performing one or more automatic compensation algorithms.

14. The system of claim 13, further comprising:
one or more light sources for illuminating a face of a user who is using the system, and wherein one of the compensation algorithms causes a level of light produced by at least one of the light sources to be adjusted based on the determination of the lighting conditions.

15. The system of claim 13, wherein the processor receives information from the camera and processes the information to determine the lighting conditions, and wherein one of the compensation algorithms is a post-processing algorithm that increases values of pixels of the captured image that are overly dark and decreases values of pixels of the captured image that are overly bright.

16. The system of claim 13, wherein the processor receives information from the camera and processes the information to determine the lighting conditions, and wherein one of the compensation algorithms is a frame rate adapting algorithm, the frame rate adaptation algorithm adjusting a frame rate of the camera based on the determination of the lighting conditions.

17. The system of claim 13, further comprising:
a video coder/decoder (codec) that compresses the captured images, and wherein one of the compensation algorithms is a compression adapting algorithm, the compression adapting algorithm adjusting an image compression level at which the captured images are compressed by the video codec based on the determination of the lighting conditions.

18. The system of claim 13, further comprising:
an external communications interface, the external communications interface being in communication with a lighting network of a premises in which the video telephony system is being used, and wherein one of the compensation algorithms causes information relating to the determination of the lighting conditions to be sent via the external communications interface to the lighting network to cause the lighting network to adjust the lighting conditions.

19. A method for improving quality of images in a video telephony system, the method comprising:
determining lighting conditions in an environment in which the video telephony system is located; and
performing one or more tasks in accordance with the determined lighting conditions to improve a quality of images captured by a camera of the video telephony system.

20. The method of claim 19, wherein said one or more tasks include informing a user of the system of the lighting conditions by causing information relating to the lighting conditions to be displayed on a display device of the system.

21. The method of claim 19, wherein said one or more tasks include causing information to be displayed on a display device of the system that suggests to the user ways to improve the lighting conditions.

22. The method of claim 19, wherein the information is displayed on the display device in the form of one or more icons.

23. The method of claim 19, wherein the information is displayed on the display device in the form of one or more lighting level indicators.

24. The method of claim 19, wherein the information is displayed on the display device in the form of text.

25. The method of claim 19, wherein the information is displayed on the display device in the form of one or more symbols.

26. The method of claim 19, wherein the determination of the lighting conditions comprises:
using one or more light sensors to sense the lighting conditions and to generate lighting information that is processed by a processor to determine the lighting conditions, the processor causing said one or more tasks to be performed based on the determination of the lighting conditions.

27. The method of claim 19, wherein the determination of the lighting conditions comprises:
processing information received in a processor of the video telephony system from a camera of the video telephony system to determine the lighting conditions, the processor causing said one or more tasks to be performed based on the determination of the lighting conditions.

28. The method of claim 19, wherein said one or more tasks include performing. one or more automatic compensation algorithms.

29. The method of claim 28, wherein one of the compensation algorithms causes a level of light produced by at least one light source that illuminates a user's face to be adjusted based on the determination of the lighting conditions.

30. The method of claim 28, wherein one of the compensation algorithms is a post-processing algorithm that increases values of pixels of the captured image that are overly dark and decreases values of pixels of the captured image that are overly bright.

31. The method of claim 28, wherein one of the compensation algorithms is a frame rate adapting algorithm, the frame rate adaptation algorithm adjusting a frame rate of the camera based on the determination of the lighting conditions.

32. The method of claim 28, wherein one of the compensation algorithms is a compression adapting algorithm, the compression adapting algorithm adjusting an image compression level at which the captured images are compressed by a video codec of the telephony system based on the determination of the lighting conditions.

33. The method of claim 28, wherein one of the compensation algorithms causes information relating to the determination of the lighting conditions to be sent via an external communications interface of thee telephony system to the lighting network to cause the lighting network to adjust the lighting conditions.

34. A computer program for improving a quality of images in a video telephony system, the computer program being embodied on a computer-readable medium, the program comprising instructions for execution by a computer, the program comprising:
instructions for determining lighting conditions in an environment in which the video telephony system is located; and
instructions for causing one or more tasks to be performed in accordance with the determined lighting conditions to improve the quality of images captured by a camera of the video telephony system.
